(19) United States
(12) Patent Application Publication
(10) Pub. No.: US 2024/0154371 A1
(43) Pub. Date: May 9, 2024

(54) ELECTRICAL CONNECTOR

(71) Applicant: Hirose Electric Co., Ltd., Yokohama (JP)

(72) Inventors: Hironori TANAKA, Kanagawa (JP); Zachary PEASE, Buffalo Grove, IL (US)

(21) Appl. No.: 17/983,081

(22) Filed: Nov. 8, 2022

(51) Int. Cl. H01R 24/38; H01R 13/03; H01R 13/15; H01R 13/42; H01R 13/516

(52) U.S. Cl. CPC H01R 24/38; H01R 13/03; H01R 13/15; H01R 13/42; H01R 13/516

(57) ABSTRACT

An electrical connector for electrically contacting to a terminal includes a plurality of plates encircling an insertion space of the terminal, and a ring encircling the plates to insert an elastic force on the plates. The plates have a predetermined electrical conductivity to carry electric power to the terminal. The ring has a less electrical conductivity than the electrical conductivity of the plates, and more elasticity than elasticity of the plates.

### BACKGROUND

### Field

The present disclosure is generally related to an electrical connector, and more specifically, to an electrical connector for electrically contacting to a power supply terminal.

### Related Art

In the related art, there are connectors in which the power supply terminal includes an elastic tubular member including a metal and capable of elastic displacement in a direction of a radius thereof, such that the power supply terminal is able to tilt toward any angle in a circumferential direction around an axis thereof or able to move in the direction of the radius.

Further, in some conventional connectors, the contact lamellae of the terminal is made by press working.

However, in the press working, a joint is formed in the cylindrical part, and solder flows in through the gap.

Thus, there is an unmet need for an electrical connector for a joint in a terminal such that solder does not flow into the space inside a terminal.

Further, applying materials with good elasticity to support the terminal would result in poor electrical conductivity, but since they are used only for spring support, conductivity is irrelevant.

### SUMMARY

The subject invention is an electrical connector for electrically contacting to a power supply terminal.

Aspects of the present disclosure involve an electrical connector for electrically contacting to a terminal, in which the electrical connector includes a plurality of plates encircling an insertion space of the terminal, and a ring encircling the plates to insert an elastic force on the plates. The plates have a predetermined electrical conductivity to carry electric power to the terminal. The ring has a less electrical conductivity than the electrical conductivity of the plates, and more elasticity than elasticity of the plates.

Aspects of the present disclosure further involve a method of making an electrical connector for electrically contacting to a terminal, including cutting a plurality of plates, arranging the plates to encircle an insertion space of the terminal, and inserting a ring to encircle the plates to insert an elastic force on the plates. The plates have a predetermined electrical conductivity to carry electric power to the terminal. The ring has a less electrical conductivity than the electrical conductivity of the plates, and more elasticity than elasticity of the plates.

With the exemplary aspects of the present disclosure, an electrical connector can be provided with a material having good conductivity with has less elasticity (i.e., poor spring characteristics), such that a high current can flow through the electrical connector. Further, since terminals are manufactured by cutting, when solder is mounted (reflow) in a through hole, solder does not flow into the space inside the terminal.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. TA illustrates an example connected side view of an electrical connector electrically contacting to a terminal, in accordance with an example implementation.

FIG. 1B illustrates an example connected cross-sectional view of an electrical connector electrically contacting to a terminal, in accordance with an example implementation.

FIG. 2A illustrates an example disconnected side view of an electrical connector electrically contacting to a terminal, in accordance with an example implementation.

FIG. 2B illustrates an example disconnected cross-sectional view of an electrical connector electrically contacting to a terminal, in accordance with an example implementation.

FIG. 3A illustrates an example side view of a pair of terminals connected to a housing, in accordance with an example implementation.

FIG. 3B illustrates an example side view of a pair of electrical connectors connected to a pair of terminals, in accordance with an example implementation.

FIG. 3C illustrates an example side view of a pair of electrical connectors with C-rings, in accordance with an example implementation.

FIG. 4A illustrates an example side view of a ring connected to an electrical connector, in accordance with an example implementation.

FIG. 4B illustrates an example side view of a ring prior to be inserted to an electrical connector, in accordance with an example implementation.

FIG. 4C illustrates an example of insertion of a ring into an electrical connector, in accordance with an example implementation.

FIG. 5 illustrates an example cross-sectional view of a terminal connected to a housing, in accordance with an example implementation.

FIG. 6 illustrates an example cross-sectional view of a terminal inserted onto a board, in accordance with an example implementation.

FIG. 7A illustrates an example side view of an electrical connector before shaping, in accordance with an example implementation.

FIG. 7B illustrates an example top view of an electrical connector before shaping, in accordance with an example implementation.

FIG. 7C illustrates an example side view of an electrical connector after shaping, in accordance with an example implementation.

FIG. 7D illustrates an example top view of an electrical connector after shaping, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

Example implementations described herein involve an electrical connector for electrically contacting to a power supply terminal.

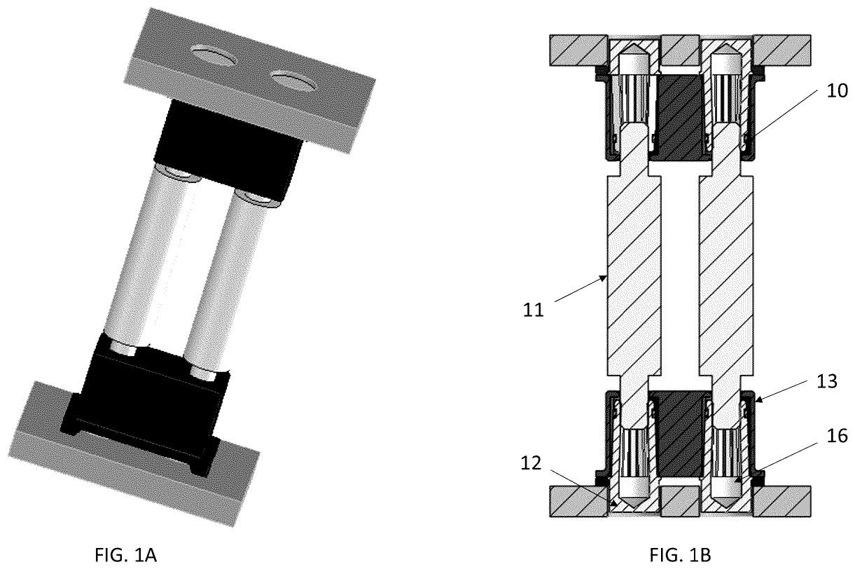

FIGS. 1A and 1B illustrate an example configuration of a connected view of the connector 16 that connects a male terminal 11 to a female terminal 12 within a housing that includes insulative case 13.

As shown in the cross-sectional view of FIG. 1B, C-ring 10 is provided at a connection area of the male terminal 11 with the female terminal 12.

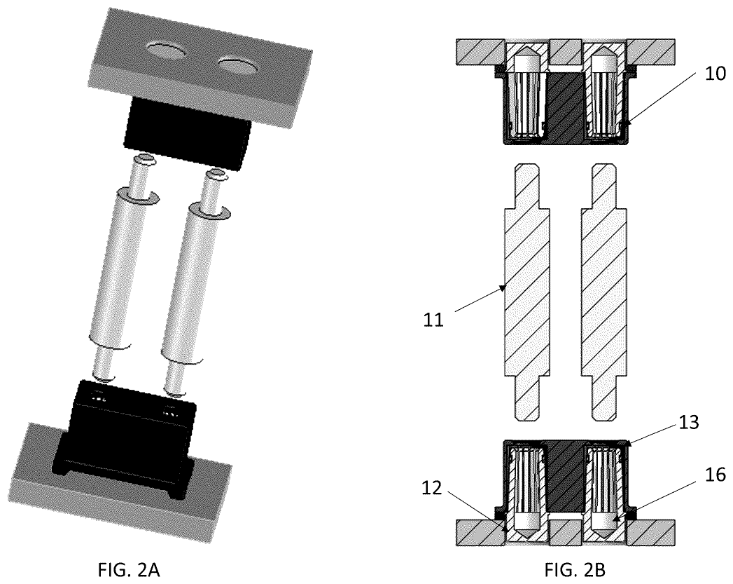

FIGS. 2A and 2B illustrate an example configuration of a disconnected view of the male terminal 11 from the female terminal 12 in which the connector 16 is inserted within the housing that includes the insulative case 13.

As shown in the cross-sectional view of FIG. 2B, C-ring 10 is provided at an end portion of the connector 16.

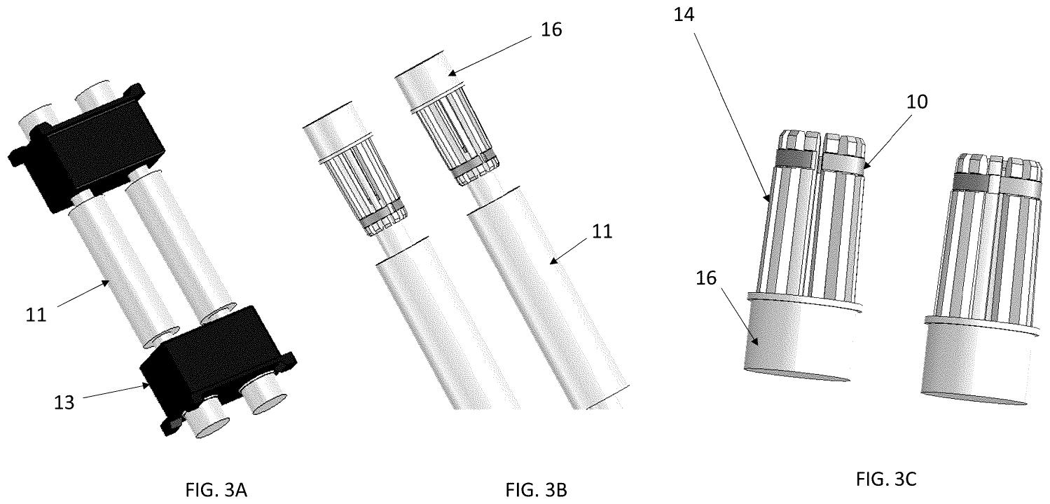

FIG. 3A illustrates an example side view of a pair of terminals 11 connected to a housing with insulative case 13, in accordance with an example implementation.

FIG. 3B illustrates an example side view of a pair of electrical connectors 16 connected to a pair of terminals 11, in accordance with an example implementation.

FIG. 3C illustrates an example side view of a pair of electrical connectors 16 each including plurality of plates 14 and ring 10, in accordance with an example implementation.

The plurality of plates 14 encircle an insertion space of the terminal 11, and ring 10 encircles the plates 14 to insert an elastic force on the plates 14.

In an exemplary aspect, ring 10 may include a C-ring with a gap in a circumferential direction of the plates 14.

Ring 10 has a less electrical conductivity than the electrical conductivity of the plates 14, such that plates 14 have a good conductivity and a poor elasticity (i.e., spring characteristics).

The material of plates 14 may be, for example, C1100 (pure copper) or C1450 (tellurium), such that a large current can flow.

Conventional connectors have a thin crown contact (t=0.2 mm), and since the spring material (C7025-TM04) is used, the conductivity is about 45%.

An exemplary aspect of the present electrical connector, depending on cutting level and spring design, may have a crown contact t=0.5 mm with a conductivity of about 100% to connect a material with good conductivity so that a large current can flow.

Ring 10 has more elasticity than the elasticity of the plates 14, and a less conductivity than the conductivity of plates 14. The material of ring 10 may be, for example, SUS631 (stainless steel). In an exemplary embodiment, the material of ring 10 may be an “insulator (non-conductor)” having a very low dielectric constant.

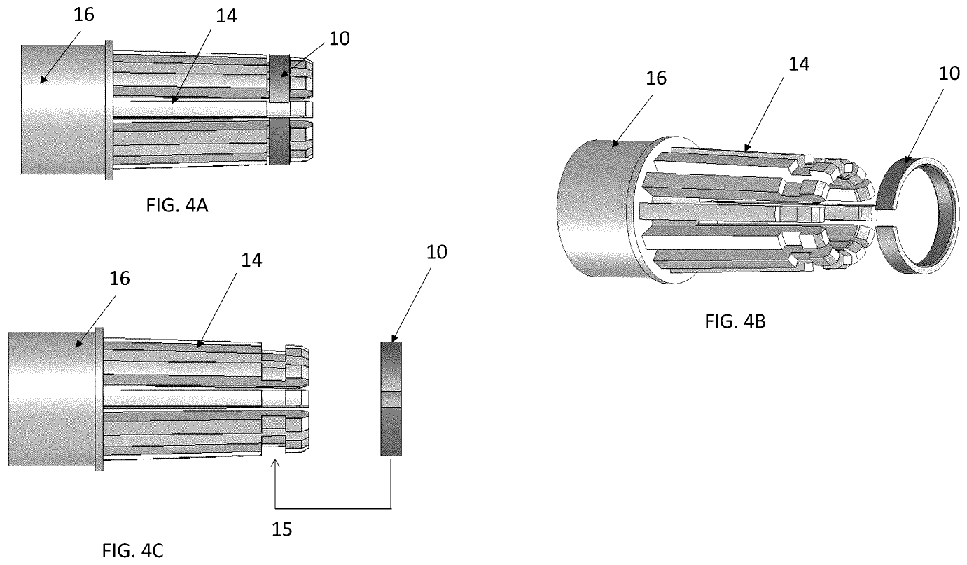

FIG. 4A illustrates an example side view of a ring 10 connected to an electrical connector 16 and plates 14, in accordance with an example implementation.

FIG. 4B illustrates an example side view of a ring 10 prior to be inserted into an electrical connector 16 and plates 14, in accordance with an example implementation.

FIG. 4C illustrates an example of insertion of a ring 10 into an electrical connector 16 that includes plates 14 via grooves 15 for insertion of the ring 10, in accordance with an example implementation.

The groves 15 are disposed towards an end portion of the plates forming a connection area for the male terminal 11 to receive the female terminal 12 in an axial direction of the electrical connector 16.

Ring 10 engages in the grooves 15 of the plates 14 to insert elastic force on the plates in a radial direction of the electrical connector 16 to tighten connections of the male terminal 11 to the female terminal 12.

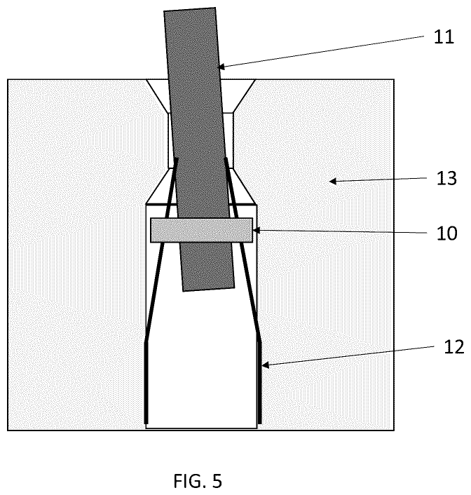

FIG. 5 illustrates an example cross-sectional view of the male terminal 11 inserted into the housing of insulative case 13 connected to the female terminal 12 via C-ring 10, in accordance with an example implementation.

In the conventional connectors, based on the shape of a drum of a terminal, it does not collide with pins even if they move to left and right.

In an exemplary aspect of the present invention, since the insulating case 13 protrudes near the contact point, the pin does not collide with the pin of the terminal even if the pin moves from side to side.

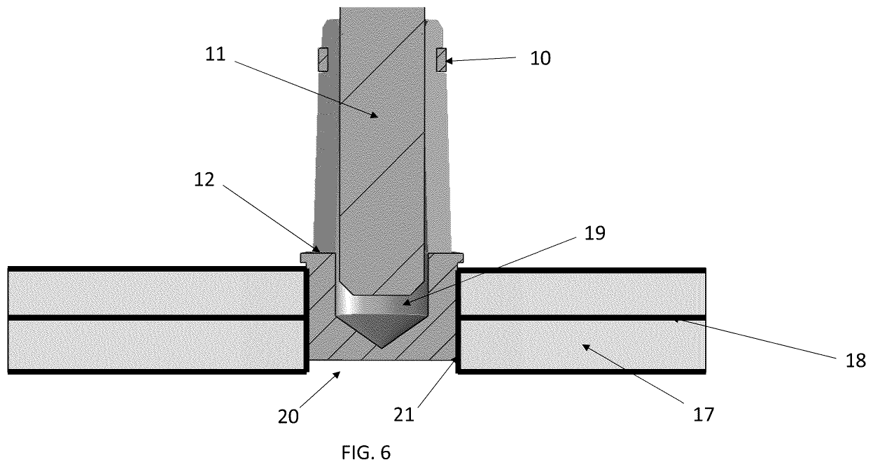

FIG. 6 illustrates an example cross-sectional view of the male terminal 11 engaged with the female terminal 12 that is inserted onto a board/PCB 17 in which power sully 18 is provided, in accordance with an example implementation.

Terminals are manufactured by cutting. Therefore, As shown in FIG. 6, when solder 21 is mounted (reflow) in the through hole 20, solder 21 does not flow into the space inside the female terminal 12.

In the case of conventional press working, a joint is formed in the cylindrical part, and solder flows in through the gap.

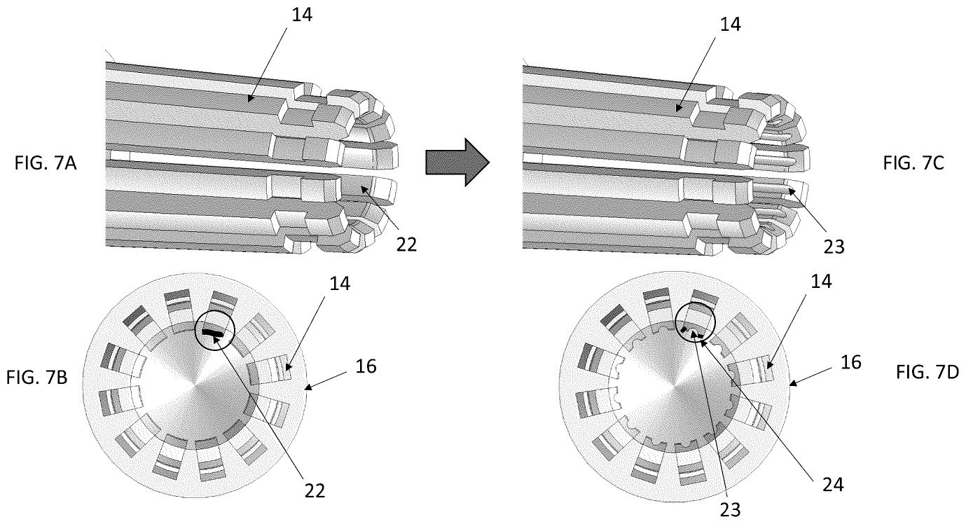

FIG. 7A illustrates an example side view of the electrical connector before shaping plates 14 with contact point 22 for contacting to the male terminal 11, in accordance with an example implementation.

FIG. 7B illustrates an example top view of the electrical connector 16 before shaping plates 14 with contact point 22 for contacting to the male terminal 11, in accordance with an example implementation.

As shown in FIGS. 7A and 7B, in the shape before processing, the contact points 22 are long, so it is not clear where they are in contact with the male terminal 11, and when viewed microscopically, there may be only one direct contact point through contact point 22.

FIG. 7C illustrates an example side view of the electrical connector after shaping plates 14 to have cut 23 via longitudinal direction of the plates 14, in accordance with an example implementation.

FIG. 7D illustrates an example top view of the electrical connector 16 after shaping plating 14 with the cut 23 such that two contact points 24 on opposing sides of cut 23 are provided on each plate 14, in accordance with an example implementation.

Since the contact points 24 shown in FIG. 7D are shorter in the shape after processing the plates 14 compared to the single contact point 22 in FIG. 7B, it can be considered that the contact points 23 will surely come into contact with the male terminal 11, and the number of contact points will clearly increase compared to before processing the plates 14.

In addition, multiple contact points are possible by providing multiple unevenness. Multiple contacts increase contact reliability. In particular, such machining can be done easily by cutting.

Another exemplary aspect of the present disclosure is directed to a method of making an electrical connector for electrically contacting to a terminal.

As shown in FIGS. 2B, 3B, 3C, 4C, 7C, and 7D, the method includes cutting a plurality of plates 14, arranging the plates 14 to encircle an insertion space of a male terminal 11, and inserting a ring 10 to encircle the plates 14 to insert an elastic force on the plates 14.

The plates 14 have a predetermined electrical conductivity to carry electric power to the male terminal 11.

The ring 10 has a less electrical conductivity than the electrical conductivity of the plates 14, and more elasticity than elasticity of the plates 14.

The plates 14 may include copper or tellurium. The ring 10 may include stainless steel. The electrical conductivity of the plates can be 100%.

The method further includes forming a groove 15 in each of the plates 14 for insertion of the ring 10.

The ring 10 may be c-shaped with a gap provided on opposing end surfaces of the ring 10 in a circumferential direction of the ring 10.

The method further includes placing the electrical connector 16 in a housing with an insulative case 13 that protrudes adjacent to a contact point of the male terminal 11 with the plates 14, and a terminal receptacle, as a female terminal 12, which is disposed between insulative case 13 and the electrical connector 16 to hold the electrical connector 16 and the male terminal 11.

The method further includes cutting through side surfaces of each of the plates 14 along a longitudinal direction of the plates 14 to provide multiple contact areas 24 for contacting to the male terminal 11 on opposing sides of a cut 23 on each of the plates 24, as shown in FIGS. 7C and 7D.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The foregoing detailed description has set forth various example implementations of the devices and/or processes via the use of diagrams, schematics, and examples. Insofar as such diagrams, schematics, and examples contain one or more functions and/or operations, each function and/or operation within such diagrams, or examples can be implemented, individually and/or collectively, by a wide range of structures. While certain example implementations have been described, these implementations have been presented by way of example only and are not intended to limit the scope of the protection. Indeed, the novel methods and apparatuses described herein may be embodied in a variety of other forms. Furthermore, various omissions, substitutions and changes in the form of the devices and systems described herein may be made without departing from the spirit of the protection. The accompanying claims and their equivalents are intended to cover such forms or modifications as would fall within the scope and spirit of the protection.

What is claimed is:

1. An electrical connector for electrically contacting to a terminal, the electrical connector comprising:
a plurality of plates encircling an insertion space of the terminal; and
a ring encircling the plates to insert an elastic force on the plates,
wherein the plates have a predetermined electrical conductivity to carry electric power to the terminal, and
wherein the ring has a less electrical conductivity than the electrical conductivity of the plates, and more elasticity than elasticity of the plates.

2. The electrical connector according to claim 1, wherein the plates comprise copper.

3. The electrical connector according to claim 2, wherein the ring comprises stainless steel.

4. The electrical connector according to claim 1, wherein the plates comprise tellurium.

5. The electrical connector according to claim 4, wherein the ring comprises stainless steel.

6. The electrical connector according to claim 1, wherein each of the plates includes a groove for insertion of the ring.

7. The electrical connector according to claim 1, wherein the ring is c-shaped with a gap provided on opposing end surfaces of the ring in a circumferential direction of the ring.

8. The electrical connector according to claim 1, wherein the electrical conductivity of the plates is 100%.

9. The electrical connector according to claim 1, wherein the electrical connector is configured to be held in an insulative case that protrudes adjacent to a contact point of the terminal with the plates, and
wherein the electrical connector and the terminal are configured to be inserted in a terminal receptacle that is disposed between the insulative case and the electrical connector.

10. The electrical connector according to claim 1, wherein each of the plates includes a cut along a longitudinal direction of the plates to provide multiple contact areas for contacting to the terminal on opposing sides of the cut of each of the plates.

11. A method of making an electrical connector for electrically contacting to a terminal, the method comprising:
cutting a plurality of plates;
arranging the plates to encircle an insertion space of the terminal; and
inserting a ring to encircle the plates to apply an elastic force on the plates, wherein the plates have a predetermined electrical conductivity to carry electric power to the terminal, and
wherein the ring has a less electrical conductivity than the electrical conductivity of the plates, and more elasticity than elasticity of the plates.

12. The method according to claim 11, wherein the plates comprise copper.

13. The method according to claim 12, wherein the ring comprises stainless steel.

14. The method according to claim 11, wherein the plates comprise tellurium.

15. The method according to claim 14, wherein the ring comprises stainless steel.

16. The method according to claim 11, further comprising forming a groove in each of the plates for insertion of the ring.

17. The method according to claim 11, wherein the ring is c-shaped with a gap provided on opposing end surfaces of the ring in a circumferential direction of the ring.

18. The method according to claim 11, wherein the electrical conductivity of the plates is 100%.

19. The method according to claim 11, further comprising placing the electrical connector in a housing that includes:
an insulative case that protrudes adjacent to a contact point of the terminal with the plates; and
a terminal receptacle that is disposed between the insulative case and the electrical connector to hold the electrical connector and the terminal.

20. The method according to claim 11, further comprising cutting side surfaces of each of the plates along a longitudinal direction of the plates to provide multiple contact areas for contacting to the terminal on opposing sides on a cut of each of the plates.
